(19) United States
(12) Patent Application Publication
(10) Pub. No.: US 2010/0017967 A1
(43) Pub. Date: Jan. 28, 2010

(54) HALOGEN FREE INSTITUTIONAL MATTRESS

(76) Inventors: Harrison MURPHY, Great Falls, VA (US); Juraj Michal Daniel Slavik, II, McLean, VA (US)

Correspondence Address: HESLIN ROTHENBERG FARLEY & MESITI PC, 5 COLUMBIA CIRCLE, ALBANY, NY, 12203, US

(21) Appl. No.: 12/483,730

(22) Filed: Jun. 12, 2009

Related U.S. Application Data
(60) Provisional application No. 61/061,019, filed on Jun. 12, 2008.

(51) Int. Cl. A47C 27/00; B32B 1/06; B32B 3/26; A47C 27/14; A47C 27/12

(52) U.S. Cl. 5/698; 428/76; 428/71

(57) ABSTRACT

A mattress, mattress foundation, upholstered furniture article, filled furnishing article or other similar composite article for use in institutional (non-residential) occupancies made with a fluid proof outer cover, a fire barrier material and a mattress core, wherein all materials used are free of halogens are presented.

### FIELD OF THE INVENTION

The invention relates to a mattress, a mattress foundation, a mattress set, an upholstered furniture article, a filled furnishing article, and other similar composite articles for use in institutional (non-residential) occupancies wherein all the materials and components of the aforementioned are free of halogens.

### BACKGROUND OF THE INVENTION

The hazards to human health potentially posed by halogens are well known and subsequently have led to profound efforts to reduce and even eliminate their use in a variety of consumer products. These efforts to-date however have been primarily focused in the electronics and wiring industries where halogen containing materials are often placed in close proximity to electrical charges and thus pose an increased risk of heat generation or ignition/combustion that may cause an undesirable creation or release of the hazardous halogen by-products when subjected to thermal decomposition.

There have been limited forays into reducing the use of halogen containing materials in selected applications within institutional environments such as healthcare facilities, educational dormitories, detention and correction facilities, and hospitality settings (hotels/motels). For instance, attempts to reduce or eliminate the use of only certain brominated flame-retardants such as PBDE and Octa-BDE used as flame retardants in textiles have been made but no concerted attempt has been made to eliminate all BFR's such as Deca-BDE.

Environmentally friendly purchasing policies have sought to encourage the purchase of chlorine-free paper products and waste processing regulations have virtually eliminated the chlorine in vinyl packaging for intravenous medical products. Yet these steps have not been assessed to determine the benefit from limiting high chlorine contents in materials such as PVC (polyvinyl chloride) mattress tickings.

According to the International Sleep Products Association (ISPA) the domestic US mattress industry shipped mattresses and foundation units in 2007 totaling 40 million pieces or roughly 20 million sets of bedding with a retail value in excess of $10 billion. Of this total domestic retail value, the ISPA reports that $378 million of this is classified as contract sales, which are institutional sales made to healthcare, lodging, dormitory, military, detention and other large-volume applications. According to the American Home Furnishings Association (AHFA) the domestic US retail sales of furniture in 2005 totaled approximately $37.6 billion. Levels of furniture sales contracts or institutional sales are on par with the percentage cited for mattresses. This would account for as much as $1.4 billion as institutional sales made to healthcare, lodging, dormitory, military, detention and other large-volume applications.

Much of the history of the structural design approach to making and assembling mattresses, mattress foundations, upholstered furniture articles, and other articles filled with resilient cushioning materials has seen the introduction of innovation in terms of small, incremental changes—for instance changes in the use of new filling materials or new cover fabrics. There have, however, recently been a number of critical factors that have occurred that have caused the need for additional changes to be made to the structural design approaches found in mattresses and mattress foundations. These and other factors also will affect future design requirements for upholstered furniture articles and filled home furnishing articles.

One factor has been the implementation of the Federal Standard for the Flammability (Open Flame) of Mattress Sets; Final Rule 16 CFR 1633. This has mandated that all mattresses sold in the United States meet an open flame, full-scale fire test. Another factor has been the increased adoption of the NFPA 101 Life Safety Code by the Federal government (Centers for Medicare and Medicaid), states (more than 40), localities, and private accreditation bodies (Joint Commission on Accreditation of Healthcare Occupancies—JCAHO). NFPA 101® calls for introduction of new mattresses and upholstered furniture into high risk occupancies (e.g. hospitals, detention facilities, dormitories, etc) that meet restricted rates of heat release when exposed to open flame ignition.

Additionally, there has been increasing activity in the areas of mandating open flame resistance in furniture and bedding through efforts such as the draft language of 16 C.F.R. 1634, as published by the CPSC in May 2005, the California BHFTI draft of Technical Bulletin #604 published Oct. 1, 2004, and the ANPR for 16 CFR 1634 Standard To Address Open Flame Ignition of Bedclothes published by the CPSC in the Federal Register on Jan. 13, 2005, pages 2514 through 2517. Compliance with full scale, open-flame ignition test performance requirements is typically achieved by mattress and furniture manufacturers by installing a fire barrier material—a fabric or batting—directly beneath the outermost covering materials used to make the mattress or article of upholstered furniture.

The composition of the barriers varies widely across a diverse manufacturing base of material suppliers. In some instances, materials selected for fire barrier design are inherently, flame retardant materials that are physically stable and pose no or low risk to users of material degradation and migration of particulate matter or chemical traces away from the barrier structure. Alternatively, however, some material suppliers have chosen less-expensive and potentially less durable solutions, such as topically applying chemical solutions such a boric acid powder to staple fibers or finished fabric barrier offerings. Such approaches fail to offer the same physical stability and resistance to degradation.

When subjected to the physical impacts commonly seen in furniture and bedding applications, a risk is potentially created that may cause particulate matter to shed from topically, chemically treated fire barrier solutions and to be made airborne. This causes the particulate matter to be moved away from the barrier, and potentially introduced into the respiratory and digestive processes of individuals intimate with the furnishing and bedding articles.

Moving toward enhanced flammability resistance directed by regulatory mandate have occurred at a time when an increasing public scrutiny is being directed at the environmental impact of the choices made in material selections for wide ranges of consumer and industrial products. Efforts have been made to target for elimination the use of halogens and heavy metals in electrical wiring and electronic components. Additional steps have sought to ban the use of certain brominated flame-retardants (BFRs) from textile and cushioning materials.

Even though the outright ban of such hazardous materials has not yet occurred, there are certification processes under way that seek to positively characterize institutions that employ purchasing and sourcing practices that are “greener” than current practices. These processes reward or commend participants for the elimination of environmentally damaging or hazardous materials from their material acquisition practices, or at a minimum that engage in efforts to minimize or reduce the quantities of potentially objectionable materials that occur in their purchases. Furthermore, grass-roots efforts that challenge organizations to select and deliver to market “greener” and less-toxic product offerings carry increasing weight in the minds of decision makers.

As such there is increasing inclination to seek out finished products that attempt to root out hidden dangers such as halogens or heavy metals. Manufacturers and suppliers that can deliver items which conform to these environmentally driven mandates stand to be viewed favorably.

Because mattresses, mattress foundations, mattress sets, upholstered furniture articles, and filled furnishing articles found in many institutional setting (e.g., hospitals, nursing homes, dormitories, and detention facilities) are required to be fluid proof so as to inhibit damage from bodily fluids and to promote service longevity of the asset investment, it has been customary to utilize materials based on halogenated plastic polymers.

Additionally, the aforementioned found in institutional settings (e.g., hospitals, nursing homes, dormitories, and detention facilities, which are termed “high-risk” occupancies from a life safety perspective) are typically required to achieve higher levels of flame retardancy and/or flame resistance than comparable articles intended for residential use. Therefore it has been customary for the manufacturers of the materials used in such articles to employ halogen and antimony-based chemical flame retardants in their product formulations.

The challenge has been to essentially re-engineer a mature type of composite article. Mattresses, furnishing, and furnishing articles have been used in institutional settings for decades and the basic design has seen little improvement or innovation in terms of the chemical profile of the materials used to make them. The performance standards required for these items—fluid resistance or fluid proofness, flame-retardance, and long term durability—have created welcoming and receptive environments for the use of halogens and heavy metals.

A need exists for an improved mattress, a mattress foundation, a mattress set, an upholstered furniture article, a filled furnishing article, or similar composite article having a fluid resistant cover for use in an institutional setting and that are free of halogens that remedy at least one of the aforementioned deficiencies.

### SUMMARY OF THE INVENTION

The present invention is directed to a mattress, mattress foundation or set thereof, comprising a fluid resistant outer cover, a fire barrier fabric and a core, wherein said cover, fire barrier, core and all materials used in construction are all comprised of materials that are free of halogens.

In one embodiment, the fluid resistant outer cover of the mattress, mattress foundation or set thereof is comprised of nylon or polyester fabric made fluid resistant by coating or lamination with a media that imparts performance attributes such as blocking of fluid transmission, blocking of moisture vapor transmission, and filtration of small particulate matter or blocking of small particulate matter. In another embodiment, the fluid resistant outer cover of the mattress, mattress foundation or set thereof is constructed with a zipper that makes the cover both removable and reinstallable.

In one embodiment, the fire barrier fabric of the mattress, mattress foundation or set thereof is comprised of a knitted, woven or non-woven textile fabric that is free of halogens. In another embodiment, the fire barrier fabric of the mattress, mattress foundation or set thereof is comprised of fiberglass or aramid fibers and is free of halogens.

In one embodiment, the invention is directed to the mattress, mattress foundation or set thereof, wherein the fluid resistant outer cover, the fire barrier fabric and the core, are also free of antimony.

In one embodiment, the core of the mattress, mattress foundation or set thereof is comprised of polyurethane foam that is free of halogens. In another embodiment, the core of the mattress, mattress foundation or set thereof is comprised of fibrous filling materials that are free of halogens. In another embodiment, the core of the mattress, mattress foundation or set thereof is comprised of a metal or wire innerspring unit that is free of halogens.

In one embodiment, the invention is directed to an upholstered furniture article, comprising a fluid resistant outer cover, a fire barrier fabric and a core, wherein said cover, fire barrier, core and all materials used in construction are all comprised of materials that are free of halogens.

In one embodiment, the fluid resistant outer cover of the upholstered furniture article of the present invention is comprised of nylon or polyester fabric made fluid resistant by coating or lamination with a media that imparts performance attributes such as blocking of fluid transmission, blocking of moisture vapor transmission, and filtration of small particulate matter or blocking of small particulate matter. In a related embodiment, the fluid resistant outer cover of the upholstered furniture article of the present invention is constructed with a zipper that makes the cover both removable and reinstallable.

In one embodiment, the fire barrier fabric of the upholstered furniture article of the present invention is comprised of a knitted, woven or non-woven textile fabric that is free of halogens. In another embodiment, the fire barrier fabric of the upholstered furniture article of the present invention is comprised of fiberglass or aramid fibers and is free of halogens.

In one embodiment, the present invention is directed to an upholstered furniture article, wherein the fluid resistant outer cover, the fire barrier fabric and the core, are also free of antimony.

In one embodiment, the core of the upholstered furniture article of the present invention is comprised of polyurethane foam that is free of halogens. In another embodiment, the upholstered furniture article of the present invention is comprised of fibrous filling materials that are free of halogens. In another embodiment, the upholstered furniture article of the present invention is comprised of a metal or wire innerspring unit that is free of halogens.

In one embodiment, the invention is directed to a furnishing article filled with resilient cushioning material, comprising a fluid resistant outer cover, a fire barrier fabric and a core, wherein said cover, fire barrier, core and all materials used in construction are all comprised of materials that are free of halogens.

In one embodiment, the fluid resistant outer cover of the furnishing article filled with resilient cushioning material is comprised of nylon or polyester fabric made fluid resistant by coating or lamination with a media that imparts performance attributes such as blocking of fluid transmission, blocking of moisture vapor transmission, and filtration of small particulate matter or blocking of small particulate matter. In a related embodiment, the fluid resistant outer cover of the furnishing article filled with resilient cushioning material is constructed with a zipper that makes the cover both removable and reinstallable.

In one embodiment, the fire barrier fabric of the furnishing article filled with resilient cushioning material is comprised of a knitted, woven or non-woven textile fabric that is free of halogens. In another embodiment, the fire barrier fabric of the furnishing article filled with resilient cushioning material is comprised of fiberglass or aramid fibers and is free of halogens.

In one embodiment, the present invention is directed to a furnishing article filled with resilient cushioning material, wherein the fluid resistant outer cover, the fire barrier fabric and the core, are also free of antimony.

In one embodiment, the core of the furnishing article filled with resilient cushioning material is comprised of polyurethane foam that is free of halogens. In another embodiment, the furnishing article filled with resilient cushioning material is comprised of fibrous filling materials that are free of halogens. In another embodiment, the furnishing article filled with resilient cushioning material is comprised of a metal or wire innerspring unit that is free of halogens.

### BRIEF DESCRIPTION OF THE DRAWINGS

FIG. 1 depicts a cross-sectional view of a mattress with a fluid proof cover and fire barrier manufactured so as to be free of halogens and antimony, according to the present invention.

FIG. 2 depicts a cross-sectional view of a set of bedding comprised of a mattress and mattress foundation each manufactured with a fluid proof cover and fire barrier so as to be free of halogens and antimony, according to the present invention.

FIG. 3 depicts a cross-sectional view of an article of upholstered furniture with a fluid proof cover and fire barrier manufactured so as to be free of halogens and antimony, according to the present invention.

FIG. 4 depicts a filled home furnishing article, a pillow, featuring a fluid proof cover, and fire barrier manufactured so as to be free of halogens and antimony, according to the present invention.

### DETAILED DESCRIPTION OF THE INVENTION

Throughout this specification the terms and substituents are defined when first introduced and retain their definitions. Throughout this application references to state and federal codes and rules, drafts of such, technical bulletins, drafts of such, articles, general publications, testing methods, patents, and published patent applications are made. The entire contents of each are incorporated herein by reference.

Terms relating to mattresses are defined in conformity with terms as defined by 16 C.F.R. §1632 and are as follow:
(a) Mattress means a ticking filled with a resilient material used alone or in combination with other products intended or promoted for sleeping upon.
   (1) This definition includes but is not limited to adult mattresses, youth mattresses, crib mattresses including portable crib mattresses, bunk bed mattresses, futons, water beds and air mattresses which contain upholstery material between the ticking and the mattress core, and any detachable mattresses used in any item of upholstered furniture such as convertible sofa bed mattresses, corner group mattresses, day bed mattresses, roll-a-way bed mattresses, high risers, and trundle bed mattresses. See Sec. 1632.8 Glossary of terms, for definitions of these items.
   (2) This definition excludes sleeping bags, pillows, mattress foundations, liquid and gaseous filled tickings such as water beds and air mattresses which do not contain upholstery material between the ticking and the mattress core, upholstered furniture which does not contain a detachable mattress such as chaise lounges, drop-arm love seats, press-back lounges, push-back sofas, sleep lounges, sofa beds (including jackknife sofa beds), sofa lounges (including glide-outs), studio couches and studio divans (including twin studio divans and studio beds), and juvenile product pads such as car bed pads, carriage pads, basket pads, infant carrier and lounge pads, dressing table pads, stroller pads, crib bumpers, and playpen pads. See Sec. 1632.8 Glossary of terms, for definitions of these items.
   (b) Mattress Pad means a thin, flat mat or cushion, and/or ticking filled with resilient material for use on top of a mattress. This definition includes, but is not limited to, absorbent mattress pads, flat decubitus pads, and convoluted foam pads which are totally enclosed in ticking. This definition excludes convoluted foam pads which are not totally encased in ticking.
   (c) Ticking means the outermost layer of fabric or related material that encloses the core and upholstery materials of a mattress or mattress pad. A mattress ticking may consist of several layers of fabric or related materials quilted together.
   (d) Core means the main support system in a mattress, mattress foundation or set thereof, in an upholstered furniture article, or in a furnishing article filled with resilient cushioning material. Examples of support system include, springs, foam, hair block, water bladder, air bladder, or resilient filling.
   (e) Upholstery material means all material, either loose or attached, between the mattress or mattress pad ticking and the core of a mattress, if a core is present.
   (f) Tape edge (edge) means the seam or border edge of a mattress or mattress pad.
   (g) Quilted means stitched with thread or by fusion through the ticking and one or more layers of upholstery material.
   (h) Tufted means buttoned or laced through the ticking and upholstery material and/or core, or having the ticking and upholstery material and/or core drawn together at intervals by any other method which produces a series of depressions on the surface. (16 C.F.R. §1632.2)
(r) A mattress foundation comprises any surface such as foam, box springs or other, upon which a mattress is placed to lend it support for use in sleeping upon. (16 C.F.R. §1632.8)

Additionally, these terms are further defined in conformity with terms as defined by the Consumer Product Safety Commission, 16 C.F.R. §1633, Standard for the Flammability (Open Flame) of Mattress Sets; Final Rule—published in the Federal Register, Mar. 15, 2006.

Terms relating to upholstered furniture are defined in conformity with terms as defined by the draft language of 16 C.F.R. §1634, as published by the C.P.S.C. in May 2005. An article of upholstered furniture is a resilient filling material that may be supported by a frame or structure and is encased by a textile structure. The article of upholstered furniture is intended to be used for sitting or reclining but is not primarily intended for sleeping.

Terms relating to filled articles and bedding are defined as follows in conformity with the terms defined by the California BHFTI draft of Technical Bulletin #604 published Oct. 1, 2004, and the ANPR for 16 CFR §1634 Standard To Address Open Flame Ignition of Bedclothes published by the CPSC in the Federal Register on Jan. 13, 2005, pages 2514 through 2517. A filled article is resilient filling material encased in a textile structure and a bedding is a textile bedding product that is used on or in conjunction with a bed, mattress, or mattress foundation.

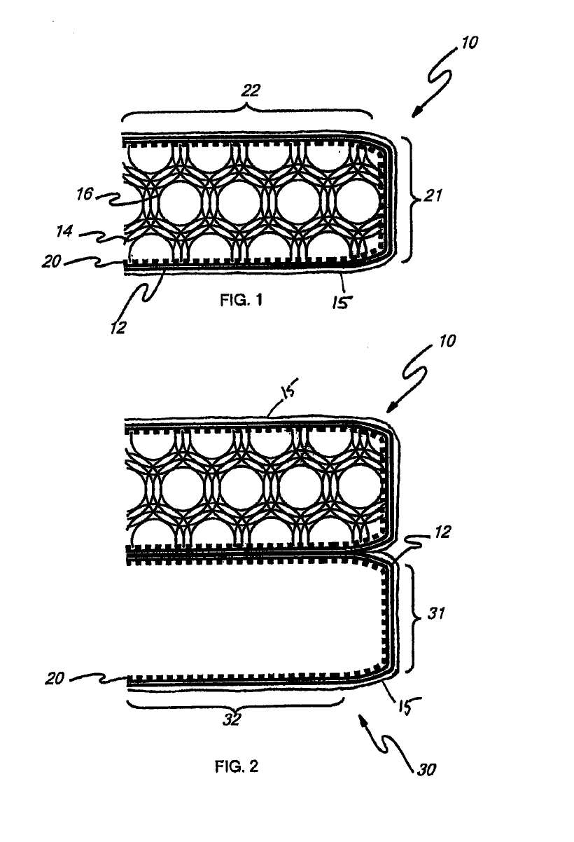

FIG. 1 depicts a cross-sectional view of a flame-resistant mattress 10, according to one embodiment of the present invention. The mattress 10 comprises a ticking cover fabric 12, ticking filling materials 14, a fluid proof cover 15, and a core 16 all of which are free of halogens and antimony. The core 16 is enclosed by a fire barrier fabric 20 that also is free of halogens and antimony. The core 16 and ticking cover fabric 12 are partially or entirely enclosed by the fire barrier fabric 20 in the mattress panel region 21 and/or the border region 22. In this embodiment, fire barrier fabric 20 may be of identical construction or may be specifically designed to address differential ignition challenges and protective requirements of the mattress panel region 21 and/or the border region 22.

As the fire barrier fabric 20 is positioned between the ticking cover fabric 12 and the ticking filling materials 14, it also encloses the filling materials associated with the ticking, and may be considered a part of the ticking of the mattress 10. In another embodiment, the fire barrier fabric 20 is positioned beneath a multilayer ticking comprising the cover fabric 12 and the filling materials 14. In another embodiment, the fire barrier fabric 20 is placed on the panel surface 22 of the mattress intended for sleeping only; for example, in mattress designs intended to be “one sided” or “non-flippable.

The fluid proof cover 15 is the outermost cover in relation to the other components of the mattress 10. The cover 15 is comprised of a material that is inherently fluid resistant or is made fluid resistant by coating or laminating the material with a medium that imparts performance attributes such as blocking fluid transmission, blocking of moisture/vapor transmission, filtration or blocking of small particulate matter, and resistance to fluid absorption. Examples of the material include but are not limited to nylon and polyester. In one embodiment, the cover 15 is constructed with a zipper that allows it to be removed from the mattress 10 and reinstalled. The fluid proof cover 15 has different degrees of resistance to a fluid depending on the end use of the product it is incorporated with. The cover 15 can be fluid resistant to 100% fluid proof and varying degrees between. One having ordinary skill in the art can differentiate between the varying degrees by employing known testing techniques to determine the aforementioned.

Resistance of the mattress 10 to ignition after exposure to an open flame is determined by full-scale testing in accordance with 16 CFR 1633. Additional full-scale fire tests available to assess the flammability resistance of the present invention include NFPA 267, 2003 edition, ASTM E 1590, or California Technical Bulletin #129. Each of these standards is essentially the same, and the entire contents of each test method are incorporated herein by reference. Results of successfully testing a mattress according to the present invention according to such additional test protocols would show a maximum heat release rate of 100 kW and a total energy release of less than 25 MJ in the first ten minutes of the test.

FIG. 2 depicts a cross-sectional view of a flame resistant mattress 10 and a flame resistant foundation 30 in accordance with the present invention. The mattress 10 and mattress foundation 30 together form what is referred to as a mattress set. Referring to FIG. 2, the mattress 10, and its elements and properties have been previously described supra and are the same when used with the mattress foundation 30. The foundation 30 comprises a ticking cover fabric 12, a fluid proof cover 15, and an optional core 16 all of which are free of halogens and antimony. The fire barrier fabric 20 encloses the core 16, if present. The core 16 and ticking cover fabric 12 are partially or entirely enclosed by the fire barrier fabric 20 in the mattress panel region 31 and/or the border region 32.

The foundation 30 is partially or entirely enclosed by the fire barrier fabric 10. In another embodiment, the foundation 30 is partially or entirely enclosed by the fire barrier fabric 10 in the mattress panel region 31 and/or the border region 32. In either of the foregoing embodiments fire barrier fabric 10 may be of identical construction or may be specifically designed to address differential ignition challenges and protective requirements of the mattress panel region 31 and/or the border region 32. For example, differences in fuel load and flammability of the mattress 10 and foundation 30. The fluid resistant cover 15 is the outermost cover in relation to the other components of the mattress foundation 30. The cover 15 for the foundation 30 possesses the same characteristics as described supra.

As state above, mattress designs that are intended to be “one-sided” or “non-flippable”, the fire barrier fabric 20 may be placed on the panel surface of the mattress intended for sleeping only. Furthermore, the fire barrier fabric 20 may only be placed on the panel surface of the foundation 30 that is in contact with the mattress 10. Resistance of the mattress set to ignition after exposure to an open flame is determined by full-scale testing in accordance with 16 CFR 1633. Additional full-scale fire tests available to assess the flammability resistance of the present invention include NFPA 267, 2003 edition, ASTM E 1590, or California Technical Bulletin #129. Each of these standards is essentially the same, and the entire contents of each test method are incorporated herein by reference. Results of successfully testing a mattress according to the present invention according to such additional test protocols would show a maximum heat release rate of 100 kW and a total energy release of less than 25 MJ in the first ten minutes of the test.

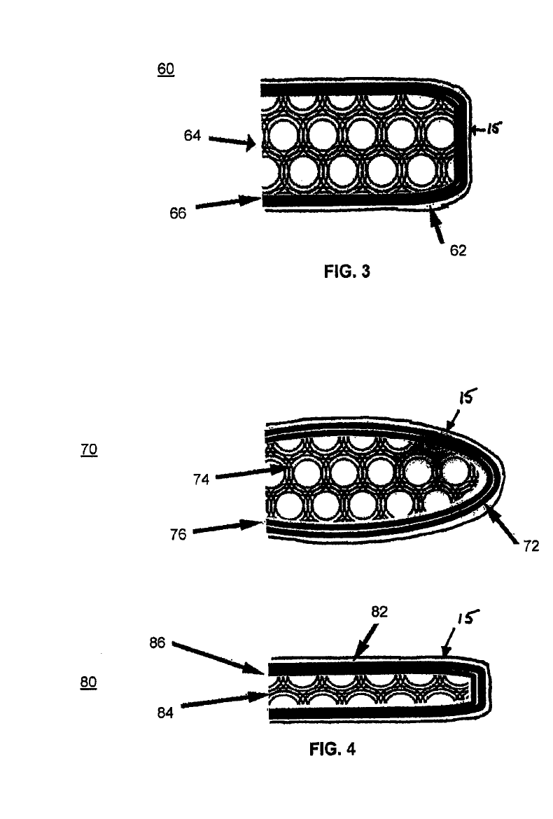

FIG. 3 shows a cross-sectional view of another embodiment of the invention, a flame resistant upholstered furniture article (a seat cushion) 60. The cushion comprises an upholstery fabric cover 62, core 64, a fire barrier fabric 66, and a fluid proof cover 15, all which are free of halogens and antimony. The core 64 is enclosed, either completely or partially, by the fire barrier fabric 66. Depending on the specific construction of the upholstered furniture article, it may be necessary to place the fire barrier 66 directly behind the upholstery fabric cover 62 or the fire barrier fabric 66 may alternatively be placed behind filling materials that are attached to the fabric cover 62.

Placement of the fire barrier fabric 66 may also be required beneath the fabric cover 62 in areas of the upholstered article other than the seating surface, including but not limited to arm supports, upright backs and leg extensions. The fluid proof cover 15 is the outermost cover in relation to the other components of the upholstered furniture article 60. The cover 15 and the fire barrier fabric 66 for the article 60 possess the same characteristics as described supra. Resistance of the upholstered furniture article 60 to ignition after exposure to an open flame is determined by successful full-scale testing in accordance with California TB 133, with maximum heat release rate of less than 80 kW and a total energy release of less than 25 MJ in the first ten minutes of the test.

FIG. 4 shows a cross-sectional view of two more embodiments of the invention, specifically a flame resistant pillow 70 and a flame resistant mattress pad 80. The flame resistant pillow 70 comprises a pillow ticking fabric 72, a resilient filling material 74, and a fluid proof cover 15, all of which are free of halogens and antimony. The resilient filling material 74 is enclosed, either completely or partially by the fire barrier 76, which also is free of halogens and antimony. The flame resistant mattress pad 80 comprises a ticking fabric 82, a resilient filling material 84, and fluid resistant cover 15. The resilient filling material 84 is enclosed, either completely or partially by fire barrier 86. The fluid resistant cover 15 is the outermost cover in relation to the other components of the flame resistant pillow 70 and the flame resistant mattress pad 80. The cover 15 for the pillow 70 and the mattress pad 80 possesses the same characteristics as described supra. In alternative embodiments, the fire barrier fabric 20 is a textile constructed to serve as a replacement in the entirety of the ticking material.

Other embodiments of a flame resistant mattress, a flame resistant mattress foundation, fire barrier fabric, a flame resistant upholstered furniture article, and a flame resistant filled furnishing article can be found in U.S. Pat. No. 6,823,548 B2, U.S. Published Patent Application No. 2004/0060120, and U.S. Published Application No. 2007/0249248.

The selection of all raw materials is carefully made to ensure that there are no halogens present in the final composite and that halogens are not used during the manufacture of any component materials or during the assembly of the composite article. Alternative embodiments of the present inventions may also utilize polyesters that are free of antimony as well as flame retardant treatments, such as those that are phosphorous based, so as to eliminate the presence of antimony.

### Example 1

### Hospital Mattress

A standard hospital sized mattress measuring 39″ wide by 75″ long by 6″ thick was prepared. The mattress was built using a solid core of poured polyurethane foam.

The polyurethane foam core selected was 1.0 pound foam with an Indentation Load Deflection (ILD) of 30. ILD is the most accurate way to measure foam's firmness. It is a measure of load bearing capacity of foam. ILD is generally measured as the force (in pounds) required to compress a 50 square inch circular indentor foot into a four inch thick foam sample no smaller than 24 inches square, to a stated percentage of the foam's initial height. Common ILD values are generated at 25% of initial height. The foam was specifically selected to be free of halogen and antimony.

The foam core was encapsulated in a sleeve of tubular knitted fire barrier fabric comprised of fiberglass, flame retardant halogen free rayon and polyester. Alternative embodiments of the knitted fire barrier comprise aramid fibers and flame-retardant halogen free rayon fibers.

The tubular knitted fire barrier sleeve was closed at each end of the foam core by gluing and overlapping the barrier at the head and foot of the mattress core using an adhesive that was free of halogens and antimony. An alternative approach to closing the tubular fire barrier sleeve is to sew the ends closed using a para-aramid thread such as SpunGold® Tex 50 sewing thread available from Ventex, Inc. of Great Falls, Va.

A fluid resistant, removable outer cover for the mattress was fashioned using two pieces of Recovery5™ Mattress Ticking, a polyester knit fabric made fluid resistant with a cast-coated (transfer coated) polyurethane film lamination. The Recovery5™ Ticking is free of halogens and antimony in that its flame retardants are halogen free and antimony free and its antibacterial and antimicrobial finishes are also halogen and antimony free. Since the urethane film is the outermost surface, there is no need to treat the material with the customary halogen containing water repellent finishes such as Teflon®. In one embodiment, a nylon or polyester fabric is used, and said nylon or polyester fabric is coated with a urethane coating that was not treated with any halogenated compounds or antimony to aid flame retardance or other performance elements.

The top half and the bottom half of the cover were joined with a zipper that transited the full lateral circumference of the mattress dimension. The cover assembly is zipped together and encapsulates the foam mattress core that has previously been encapsulated in the tubular fire barrier fabric sleeve.

Three specimens of the mattress were prepared. The specimens were subjected to full scale fire testing under 16 CFR 1633. The results of this testing appear in Table 1, and show that the mattress specimens met the performance requirements of the test.

TABLE 1
Full-Scale Fire Testing of Mattress Specimens under 16 CFR 1633

| | Test | | Peak Heat | Total MJ @ | Ceiling | |
|---|---|---|---|---|---|---|
| Test # | Standard | Specimen # | Release Rate | 10 min | Temp | Result |
| XXX899-26 | 16 CFR 1633 | 1 | 31 kW | 8.9 | 182° F. | PASS |
| XXX899-27 | 16 CFR 1633 | 2 | 30 kW | 8.1 | 185° F. | PASS |
| XXX899-28 | 16 CFR 1633 | 3 | 33 kW | 8.8 | 184° F. | PASS |

It will be evident to one skilled in the art that the scope of the invention is not limited to the above stated examples, but can be extended to include a variety of home furnishings in a variety of dimensions and configurations. Additionally, the dimensions, and number of constituting materials do not serve to limit the invention in any way, as will be apparent to one skilled in the art.

### Testing

The mattress of the present invention was subjected to full-scale, open flame resistant testing under the 16 CFR 1633 test method. Methods to analyze for the presence of halogens and antimony in the components that comprise the present invention include the use of portable x-ray fluoroscopy (XRF) or destructive materials analysis such as BS EN14582:2007, IEC 62321:2008 or US EPA Method 3050B. As shown in Table 1 supra, each of the three specimens passed the requirements of the test, thereby establishing this design as an institutional mattress that is halogen and antimony free.

Raw material ingredients used in the ticking material, the fire barrier material and the core materials of the present invention have been chosen to be free of halogens and antimony. These selections remove many customarily used flame retardants from inclusion into the mattress or other articles according to the present invention. Since the performance evaluation of flammability resistance is predicated on a full-scale fire test of the composite article, the use of ticking and core materials that are free of halogenated flame retardants or antimony based flame retardants requires that enhanced protective capability be engineered into the fire barrier selection.

Testing of the ticking, fire barrier and core under protocols including portable x-ray fluoroscopy (XRF) or destructive materials analysis such as BS EN14582:2007, IEC 62321:2008 or US EPA Method 3050B, returned the results that appear in Table 2.

TABLE 2
Material Analysis of Institutional Mattress Components

| | Component | | |
|---|---|---|---|
| | Ticking | Fire Barrier | Core |
| | Test Method | | |
| | | BS EN14582: 2007 (Cl, Br) | BS EN14582: 2007 (Cl, Br) |
| | | US EPA 3050B (Sb) | US EPA 3050B (Sb) |
| Element | XRF | IEC 62321: 2008 (Pb, Hg) | IEC 62321: 2008 (Pb, Hg) |
| Chlorine (Cl) | Not Detected | Not Detected | Not Detected |
| Bromine (Br) | Not Detected | Not Detected | Not Detected |
| Antimony (Sb) | <0.002% | <0.002% | Not Detected |
| Lead (Pb) | Not Detected | Not Detected | Not Detected |
| Mercury (Hg) | <0.001% | Not Detected | Not Detected |

The test results in Table 2 show that no Chlorine, Bromine or Lead was detected in either the ticking, fire barrier or the core, under any of the test methods. Mercury and Antimony were detected at less than 0.001% and less than 0.002% respectively, in the ticking using the XRF method.

Also, halogen-free water repellant finishes need not compromise the water repellant nature or durability of the ticking material as alternative selections may be made such as the use of silicones, waxes or other fluid proof elements that are free of halogens and antimony. Furthermore, design changes such altering the orientation of the material for example to place a coating side that is free of halogens and antimony where the objectionable finish was located.

Although certain preferred embodiments of the present invention have been described above in detail that is only by way of illustration and example. Those of ordinary skill in the art will now appreciate that modifications and adaptations of this invention can be made to many environments of use and that the examples given are frames of reference only and not application specific requirements. Accordingly, the spirit and scope of the present invention are to be limited only by the terms of the claims below.

It is claimed:

1. A mattress, mattress foundation or set thereof, comprising a fluid resistant outer cover, a fire barrier fabric and a core, wherein said cover, fire barrier, and core are all comprised of materials that are free of halogens.

2. A fluid resistant outer cover according to claim 1, comprised of nylon or polyester fabric made fluid resistant by coating or lamination with a media that imparts performance attributes such as blocking of fluid transmission, blocking of moisture vapor transmission, and filtration of small particulate matter or blocking of small particulate matter.

3. A fluid resistant outer cover according to claim 1, wherein said fluid resistant outer cover is constructed with a zipper that makes the cover both removable and reinstallable.

4. A fire barrier fabric according to claim 1, comprised of a knitted, woven or non-woven textile fabric that is free of halogens.

5. A fire barrier fabric according to claim 1, comprised of fiberglass or aramid fibers and is free of halogens.

6. A mattress, mattress foundation or set thereof according to claim 1, wherein the fluid resistant outer cover, the fire barrier fabric and the core, are also free of antimony.

7. A mattress core according to claim 1, comprised of polyurethane foam that is free of halogens.

8. A mattress core according to claim 1, comprised of fibrous filling materials that are free of halogens.

9. A mattress core according to claim 1, comprised of a metal or wire innerspring unit that is free of halogens.

10. An upholstered furniture article, comprising a fluid resistant outer cover, a fire barrier fabric and a core, wherein said cover, fire barrier, and core are all comprised of materials that are free of halogens.

11. A fluid resistant outer cover according to claim 10, comprised of nylon or polyester fabric made fluid resistant by coating or lamination with a media that imparts performance attributes such as blocking of fluid transmission, blocking of moisture vapor transmission, and filtration of small particulate matter or blocking of small particulate matter.

12. A fluid resistant outer cover according to claim 10, wherein said fluid resistant outer cover is constructed with a zipper that makes the cover both removable and reinstallable.

13. A fire barrier fabric according to claim 10, comprised of a knitted, woven or non-woven textile fabric that is free of halogens.

14. A fire barrier fabric according to claim 10, comprised of fiberglass or aramid fibers and is free of halogens.

15. An upholstered furniture article according to claim 10, wherein the fluid resistant outer cover, the fire barrier fabric and the core, are also free of antimony.

16. A core according to claim 10, comprised of polyurethane foam that is free of halogens.

17. A core according to claim 10, comprised of fibrous filling materials that are free of halogens.

18. A core according to claim 10, comprised of a metal or wire innerspring unit that is free of halogens.

19. A furnishing article filled with resilient cushioning material, comprising a fluid resistant outer cover, a fire barrier fabric and a core, wherein said cover, fire barrier, and core are all comprised of materials that are free of halogens.

20. A fluid resistant outer cover according to claim 19, comprised of nylon or polyester fabric made fluid resistant by coating or lamination with a media that imparts performance attributes such as blocking of fluid transmission, blocking of moisture vapor transmission, and filtration of small particulate matter or blocking of small particulate matter.

21. A fluid resistant outer cover according to claim 19, wherein said fluid resistant outer cover is constructed with a zipper that makes the cover both removable and reinstallable.

22. A fire barrier fabric according to claim 19, comprised of a knitted, woven or non-woven textile fabric that is free of halogens.

23. A fire barrier fabric according to claim 19, comprised of fiberglass or aramid fibers and is free of halogens.

24. A furnishing article filled with resilient cushioning material according to claim 19, wherein the fluid resistant outer cover, the fire barrier fabric and the core, are also free of antimony.

25. A core according to claim 19, comprised of polyurethane foam that is free of halogens.

26. A core according to claim 19, comprised of fibrous filling materials that are free of halogens.

27. A core according to claim 19, comprised of a metal or wire innerspring unit that is free of halogens.
